(19) United States
(12) Patent Application Publication
(10) Pub. No.: US 2007/0296371 A1
(43) Pub. Date: Dec. 27, 2007

(54) Position sensorless control apparatus for synchronous motor

(75) Inventor: Yasuaki Aoki, Kariya-shi (JP)

Correspondence Address: OLIFF & BERRIDGE, PLC, P.O. BOX 320850, ALEXANDRIA, VA, 22320-4850, US

(73) Assignee: DENSO CORPORATION, Kariya-City (JP)

(21) Appl. No.: 11/806,963

(22) Filed: Jun. 5, 2007

(30) Foreign Application Priority Data
Jun. 13, 2006 (JP) 2006-163522

(51) Int. Cl. H02P 1/46

(52) U.S. Cl. 318/700

(57) ABSTRACT

The position sensorless control apparatus is for controlling a synchronous motor having a permanent magnet rotor structure by generating fundamental voltage vectors used to designate on/off states of switching devices included in an inverter circuit thereof. The position sensorless control apparatus includes a current change rate detecting section detecting, as a current change rate, a change rate of a phase current flowing through the synchronous motor when a predetermined one of the fundamental voltage vectors is being generated, and a rotor magnetic pole position estimating section estimating, as a rotor magnetic pole position, a rotational position of a rotor of the synchronous motor on the basis of the current change rate detected by the current change rate detecting section.

### CROSS-REFERENCE TO RELATED APPLICATION

This application is related to Japanese Patent Application No. 2006-163522 filed on Jun. 13, 2006, the contents of which are hereby incorporated by reference.

### BACKGROUND OF THE INVENTION

1. Field of the Invention

The present invention relates to a control apparatus for a synchronous motor, particularly relates to a position sensorless control apparatus capable of controlling a synchronous motor having a magnet rotor structure without using a position sensor for detecting a position of a magnetic pole of a rotor of the synchronous motor.

2. Description of Related Art

There are known various control methods for controlling a permanent magnet type synchronous motor without using a position sensor. One example is the one called “120-degree induced voltage method” in which the rotor magnetic pole position is estimated on the basis of an induced voltage zero-cross in a 60-degree idle period. Another example is the one called “extended induced voltage method” in which an induced voltage is calculated theoretically in order to estimate the rotor magnetic pole position (for example, refer to “Position and Velocity Sensorless Controls of Cylindrical Brushless DC Motors isturbance Observers and Adaptive Velocity Estimators” by Zhiquian Chen and four others, T. IEE Japan, Vol. 118-D, No. 7/8, '98, pp. 828-835).

However, the 120-degree induced voltage method has a problem in that, sine the idle period has to be provided, and the energization waveform is rectangular, efficiency is low and vibration is large. On the other hand, the extended induced voltage method provides high efficiency and does not cause large vibration, because the energization waveform is sinusoidal. However, since computation load is high, it has problem in that an expensive high-performance microcomputer is needed, and also man-hour are needed to adjust estimated gains and device constants.

### SUMMARY OF THE INVENTION

The present invention provides a position sensorless control apparatus for controlling a synchronous motor having a permanent magnet rotor structure by generating fundamental voltage vectors used to designate on/off states of switching devices included in an inverter circuit thereof, the position sensorless control apparatus comprising:

a current change rate detecting section detecting, as a current change rate, a change rate of a phase current flowing through the synchronous motor when a predetermined one of the fundamental voltage vectors is being generated; and

a rotor magnetic pole position estimating section estimating, as a rotor magnetic pole position, a rotational position of a rotor of the synchronous motor on the basis of the current change rate detected by the current change rate detecting section.

According to the present invention, since it is possible to supply power to a synchronous motor by sinusoidal wave, the synchronous motor can be driven at high efficiency and low noise. In addition, since the present invention requires less computation load than the conventional extended induced voltage method in which the induced voltage is calculated theoretically, control delay does not occur.

The current change rate detecting section may detect the current change rate when a zero voltage vector is being generated so that the phase current is caused only by an induced voltage.

The position sensorless control of the invention may be configured to perform two-phase modulation control.

The current change rate detecting section may detect the current change rate when a non-zero voltage vector is being generated so that the phase current is caused by an induced voltage and a power supply voltage of the synchronous motor.

The position sensorless control apparatus of the invention may further comprise a memory for storing, as a zero-speed current change rate, the current change rate detected by the current change rate detecting section when the non-zero voltage vector is being generated during a zero-speed operation of the synchronous motor, and the rotor magnetic pole position estimating section may be configured to subtract the zero-speed current change rate stored in the memory from the rotor magnetic pole position estimated by the current change rate detecting section not during the zero-speed operation.

The rotor magnetic pole position estimating section may estimate the rotor magnetic pole position by detecting a direction of zero crossing of the detected current change rate.

The rotor magnetic pole position estimating section may be configured to estimate a rotational speed of the rotor on the basis of intervals of zero crossings of the current change rate detected by the current change rate detecting section, and correct the rotor magnetic pole position estimated by the rotor magnetic pole position estimating section in accordance with the estimated rotational speed of the rotor.

The position sensorless control apparatus of the invention may further comprise a current detecting circuit detecting the phase current, and the current change rate detecting section may detect the current change rate on the basis of the phase current detected by the current detecting circuit.

The current detecting circuit may detect the phase current on the basis of a voltage drop across at least one of the switching devices.

The current detecting circuit may detect the phase current on the basis of a current flowing through a shunt resistor provided in at least one of phase arms of the inverter circuit.

The current detecting circuit may detect the phase current on the basis of a current flowing through a shunt resistor provided in a DC current bus of the inverter circuit.

The current detecting circuit may detect the phase current on the basis of outputs of current sensors provided for each phase in the inverter circuit.

The position sensorless control apparatus of the invention may further comprise an A/D converter for A/D converting the phase current detected by the current detecting circuit, and the current change rate detecting section may be configured to cause the A/D converter to operate twice during a period in which the predetermined one of the fundamental voltage vectors is being generated in order to detect the current change rate on the basis of two values of the phase current taken in at different timings.

The current change rate detecting section may include two sample-hold circuits for holding two values of the phase current detected at different timings by the current detecting circuit during a period in which the predetermined one of the fundamental voltage vectors is being generated, and a difference calculating circuit for calculating a difference between the two values of the phase current stored in the two sample-hold circuits, and may be configured to detect the current change rate on the basis of the difference calculated by the difference calculating circuit.

The current change rate detecting section may include a differentiating circuit for differentiating the phase current detected by the current detecting circuit, and may be configured to detect the current change rate on the basis of a derivative of the phase current outputted from the differentiating circuit.

The rotor magnetic pole position estimating section may be configured to d-q convert the current change rate detected by the current change rate detecting section, and estimate the rotor magnetic pole position on the basis of a ratio between a d-axis component and a q-axis component of the d-q converted current change rate.

The rotor magnetic pole position estimating section may be configured to d-q convert the current change rate detected by the current change rate detecting section, and estimate the rotor magnetic pole position to be a value at which a d-axis component of the d-q converted current change rate becomes substantially zero.

The rotor magnetic pole position estimating section may be configured to d-q convert the current change rate detected by the current change rate detecting section, and estimate the rotor magnetic pole position to be a value at which a scalar product of a d-q component vector of the d-q converted current change rate and an estimated position vector of the rotor becomes substantially zero.

The rotor magnetic pole position estimating section may be configured to α-β convert the current change rate detected by the current change rate detecting section, and estimate the rotor magnetic pole position on the basis of a ratio between an α-axis component and α β-axis component of the α β converted current change rate.

The rotor magnetic pole position estimating section may be configured to α-β convert the current change rate detected by the current change rate detecting section, and estimate the rotor magnetic pole position to be a value at which a scalar product of an α-β component vectorofthe α-β convertedcurrent change rate and an estimated position vector of the rotor becomes substantially zero.

The rotor magnetic pole position estimating section may be configured to correct the estimated rotor magnetic pole position in accordance with the phase current flowing to the synchronous motor.

The rotor magnetic pole position estimating section may be configured to estimate a rotational speed of the rotor on the basis of the estimated rotor magnetic pole position, integrate the estimated rotational speed when a period during which the predetermined one of the fundamental voltage vectors is being generated is shorter than a predetermined value, and estimate the rotor magnetic pole position on the basis of integration result of the estimated speed.

Other advantages and features of the invention will become apparent from the following description including the drawings and claims.

### BRIEF DESCRIPTION OF THE DRAWINGS

In the accompanying drawings:

FIG. 1 is a circuit diagram showing an electrical structure of a synchronous motor control apparatus according to an embodiment of the invention;

FIG. 2 is a diagram showing fundamental voltage vectors;

FIG. 3 is a diagram showing relationships among a rotor magnetic pole position, a U-phase induced voltage, a U-phase current, and a slope of the U-phase current when a zero voltage vector is being generated;

FIGS. 4A to 4D are diagrams each showing a voltage state of a synchronous motor when a voltage vector is being generated;

FIG. 5 is a chart showing a modification rate with respect to electrical angle for each phase;

FIG. 6 is a chart showing a variation of a current ripple around 120 degree electrical angle;

FIG. 7 is a flowchart showing a flow of a rotor magnetic pole position estimating process;

FIG. 8 is a time diagram showing relationships among the rotor magnetic pole position, phase induced voltages of U-, V-, an W-phase, and slopes of U-, V-, and W-phase currents when the zero voltage vector is being generated;

FIG. 9 is a diagram showing relationships among the rotor magnetic pole position, U-phase induced voltage, U-phase current, and slope of the U-phase current when a non-zero voltage vector is being generated;

FIG. 10 is a diagram showing a structure of a variant of the embodiment shown in FIG. 1, in which phase current detection is performed by use of shunt resistors respectively provided below a U-, V-, and W-phase arms.

FIG. 11 is a diagram showing a structure of a variant of the embodiment shown in FIG. 1, in which phase current detection is performed by use of a single shunt resistor provided in a DC bus of an inverter circuit;

FIG. 12 is a table showing relationships among the fundamental voltage vectors, switching patterns of switching transistors of the inverter circuit, and detected phase currents;

FIG. 13 is a diagram showing a structure of a variant of the embodiment shown in FIG. 1, in which the phase current detection is performed by use of current sensors respectively provided in the U-phase, and V-phase;

FIG. 14 is a diagram showing a structure of a variant of the embodiment shown in FIG. 1, in which two sample-hold circuits for holding a detected current value, and a difference calculating circuit are provided;

FIG. 15 is a diagram showing a structure of a variant of the embodiment shown in FIG. 1, in which a differentiating circuit for differentiating the detected current value is provided;

FIG. 16 is a diagram for explaining d-q conversion; and

FIG. 17 is a diagram for explaining α-β conversion.

### PREFERRED EMBODIMENTS OF THE INVENTION

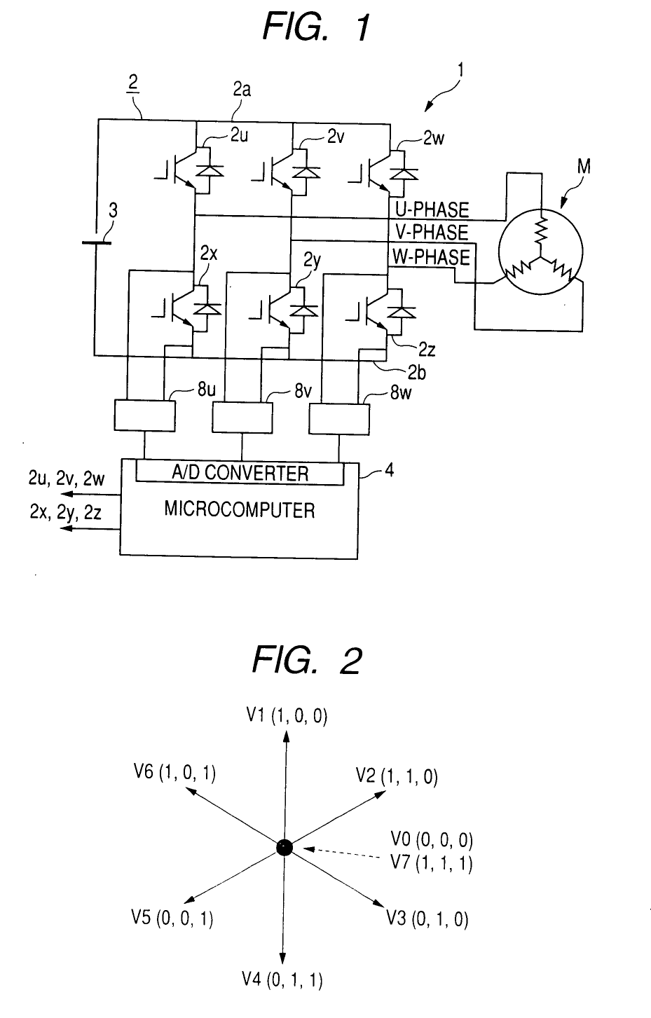

FIG. 1 is a circuit diagram showing an electrical structure of a synchronous motor control apparatus 1 according to an embodiment of the invention.

The synchronous motor control apparatus 1 is constituted by an inverter circuit 2, a DC power source 3, a microcomputer 4 including an A/D converter for detecting phases currents, and current detecting circuits 8u, 8v, 8w each constituted by an operational amplifier. The inverter circuit 2 supplies electric power to each of a U-phase, a V-phase, and a W-phase of a synchronous motor M having a permanent magnet rotor structure. The DC power source 3 supplies electric power to the inverter circuit 2. The microcomputer 4 generates a PWM signal having a duty ratio depending on an external command designating an inverter output voltage.

The inverter circuit 2 is a three-phase inverter circuit having a structure in which 6 power switching devices are bridge-connected between a DC bus 2a and a DC bus 2b. The 6 switching devices include a power MOSFET (referred to simply as a transistor hereinafter) 2u disposed above a U-phase arm, a transistor 2x disposed below the U-phase arm, a transistor 2v disposed above a V-phase arm, a transistor 2y disposed below the V-phase arm, a transistor 2w disposed above a W-phase arm, and a transistor 2z disposed below the W-phase arm.

The current detecting circuit 8u operates to detect a phase current passing through the U-phase arm on the basis of a voltage drop across the transistor 2x disposed below the U-phase arm. The current detecting circuit 8v operates to detect a phase current passing through the V-phase arm on the basis of a voltage drop across the transistor 2y disposed below the V-phase arm. The current detecting circuit 8w operates to detect a phase current passing through the W-phase arm on the basis of a voltage drop across the transistor 2z disposed below the W-phase arm.

Next, explanation is given as to how the PWM signal is generated by using a spatial vector method. The spatial vector method is a method in which a command voltage vector is represented by fundamental voltage vectors used for determining on/off states of the six switching transistors. The fundamental voltage vectors includes 8 kinds of vectors to designate one of 8 (=2³) on/off combinations of the six switching transistors. As shown in FIG. 2, the fundamental voltage vectors includes 6 voltage vectors V1 to V6 having the same absolute value and directions at 60-degree intervals, and two zero voltage vectors V0, V7 having the absolute value of zero. These 8 vectors (Sa, Sb, Sc) corresponds to 8 switching modes. When the switching transistors 2u, 2v, 2w on the positive phase side are to be turned on, the vector elements Sa, Sb, Sc are respectively set at 1. While, when the switching transistors 2x, 2y, 2z on the negative phase side are to be turned on, the vector elements Sa, Sb, Sc are respectively set at 0. In this embodiment, a three-phase PWM voltage is generated by use of combination of these 8 fundamental voltage vectors.

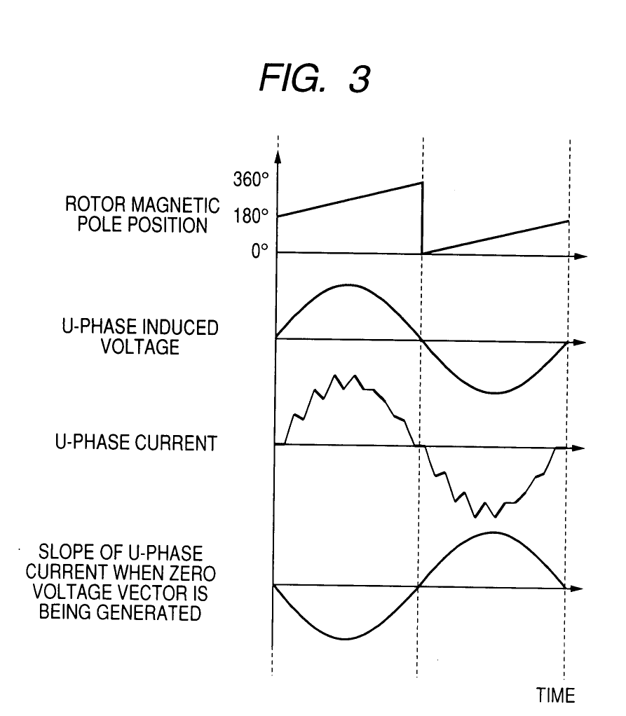

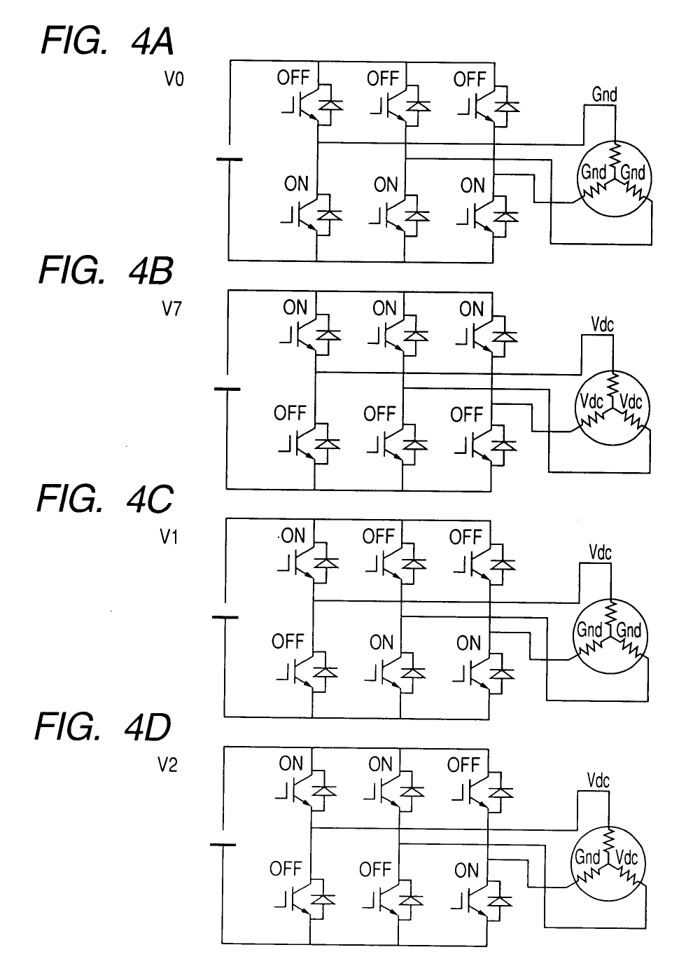

Next, explanation is given to a principle for estimating a magnetic pole position of a rotor of the synchronous motor M on the basis of change of the phase current of each phase. FIG. 3 is a time diagram showing relationships among the rotor magnetic pole position, a U-phase induced voltage, a U-phase current, and a slope of the U-phase current (or a change amount of the U-phase current per a predetermined time interval) when the voltage vector V0 is being generated. In FIG. 3, the U-phase current is shown by thick lines during periods in each of which the zero voltage vector V0 or V7 is being generated, and by thin lines during periods in each of which the non-zero voltage vector of one of V1 to V6 is being generated. FIGS. 4A to 4d are diagrams showing a voltage state of each phase when the voltage vector V0, voltage vector V7, voltage vector V1, and voltage vector V2 are being generated respectively.

As shown in FIG. 3, since there is a correlation between the rotor magnetic pole position and the phase induced voltage, the rotor magnetic pole position can be estimated by detecting the phase induced voltage. As seen from FIG. 3, during period in which the zero voltage vector V0 or V7 is being generated, there is a correlation between the induced voltage and the slope of the phase current (the change amount of the phase current per a predetermined interval), because each phase is in a short-circuited state (see FIGS. 4A, 4B), and accordingly a current depending on the induced voltage flows in each phase during this period. Accordingly, by detecting the slope of the phase current when the zero voltage vector is being generated, it becomes possible to detect the induced voltage, and to estimate the rotor magnetic pole position. Incidentally, during the period in which one of the non-zero voltage vectors V1 to V6 is being generated, a current depending on a sum of the induced voltage and a power supply voltage Vdc flows in each phase (see FIGS. 4C, 4D).

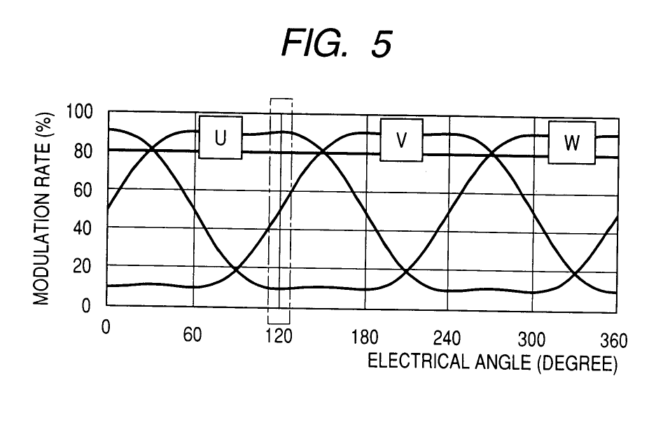

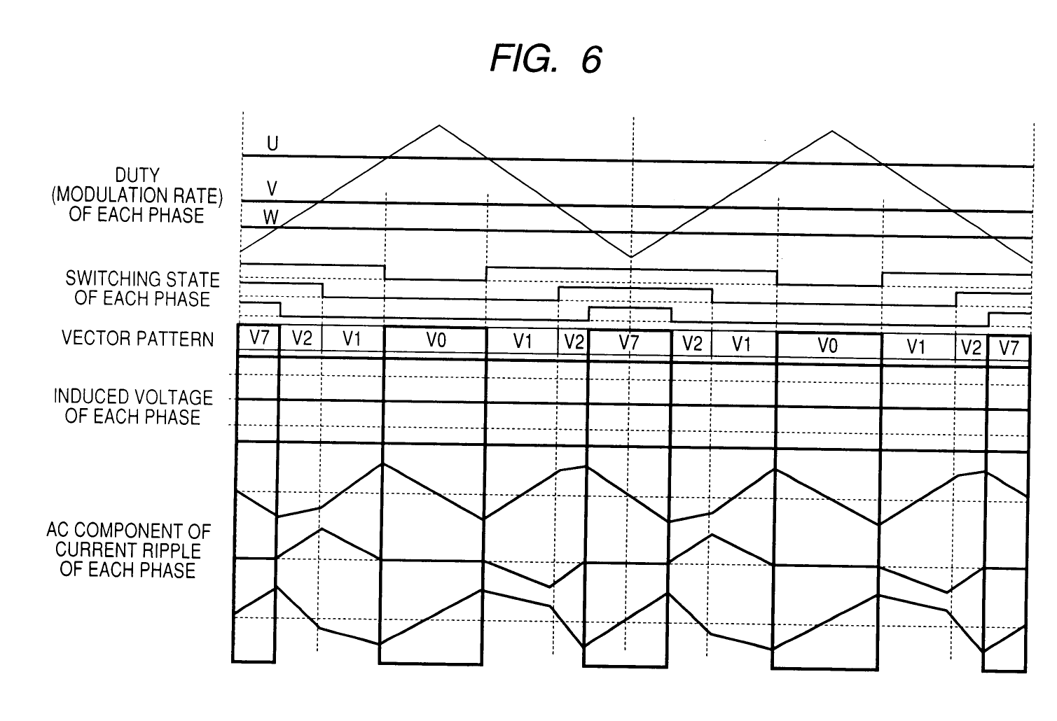

Next, one example of current ripple variation in the inverter circuit 2 is explained. FIG. 5 is a chart showing a modulation rate with respect to electrical angle for each phase. FIG. 6 is a chart showing a variation of current ripple around 120 degree electrical angle (around an area surrounded by a dashed line in FIG. 5). In this chart, there are shown a modulation rate (duty), a switching state, a voltage vector pattern, an induced voltage, and an AC component of the current ripple for each of the U-phase, V-phase, and W-phase. A U-phase current ripple component when the zero voltage vector V0, or V7 is being generated shown in FIG. 6 corresponds to the thick line portion of the U-phase current shown in FIG. 3, and the slope of the U-phase current when the zero voltage vector V0, or V7 is being generated shown in FIG. 6 corresponds to the slope of the U-phase current shown in FIG. 3.

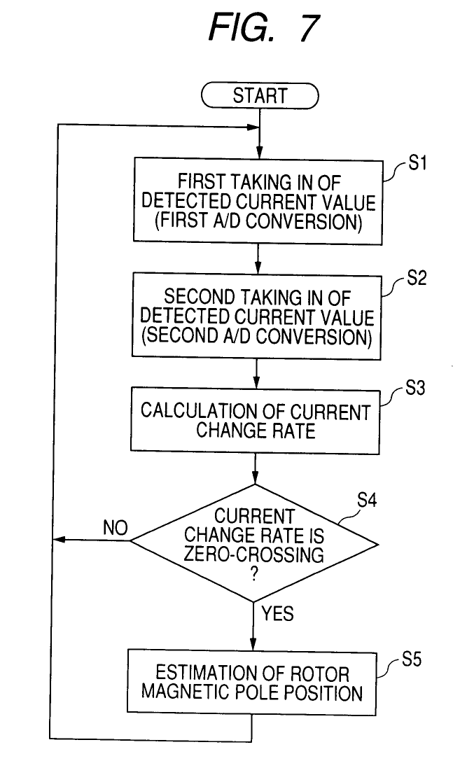

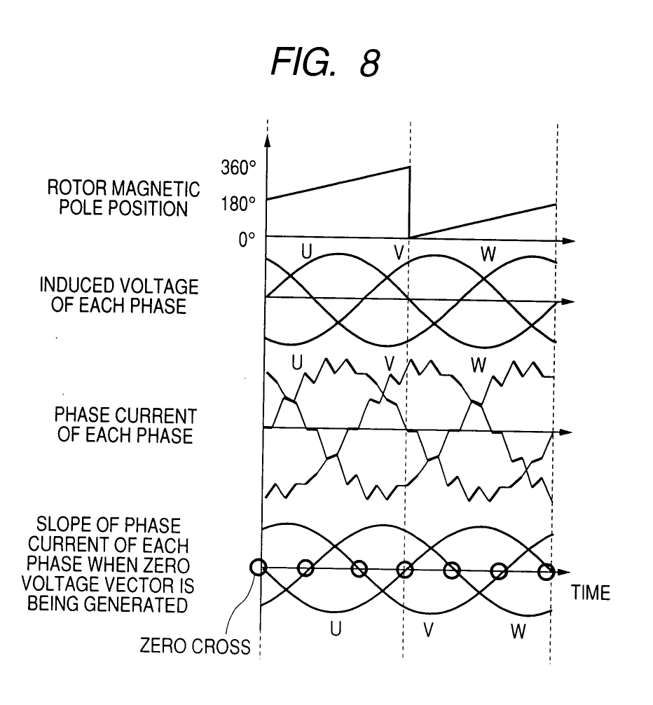

Next, explanation is given as to a process for estimating the rotor magnetic pole position with reference to a flowchart of FIG. 7 and a time diagram of FIG. 8.

This rotor magnetic pole position estimating process begins by taking in, at step S1, a current value detected on the first time around during a period in which the zero voltage vector V0 or V7 is being generated for each of the U-phase, V-phase, and W-phase. More specifically, at step S1, the microcomputer 4 generates an A/D conversion interruption in order to take in the detected current value from each of the current detecting circuits 8u, 8v, 8w, and A/D-convert it. At subsequent step S2, a current value detected on the second time around is taken in for each phase. That is, like at step S1, at step S2, the microcomputer 4 generates an A/D conversion interruption in order to take in the detected current value from each of the current detecting circuits 8u, 8v, 8w and A/D-convert it. After that, at step S3, the current value detected in the second time is subtracted by the current value detected in the first time to calculate the current change rate (current slope) for each phase. Next, it is judged at step S4 whether or not the calculated current change rate is at a zero crossing point (white circle portions in FIG. 8) for each of the U-phase, V-phase, and W-phase. More specifically, if the sign of the current change rate calculated previous time is opposite to that of the current change rate calculated this time, it is judged that the current change rate calculated this time is at the zero crossing point. When it is judged that the calculated current change rate is at the zero crossing point at step S4, the process proceeds to step S5 where the rotor magnetic pole position is estimated in accordance with a pattern of the zero crossing. For example, if the zero crossing that has occurred is the one from a positive value to a negative value of the U-phase current change rate, the rotor magnetic pole position is estimated to be 180 degrees. Likewise, if the zero crossing is the one from a negative value to a positive value of the W-phase current change rate, the rotor magnetic pole position is estimated to be 240 degrees, if it is the one from a positive value to a negative value of the V-phase current change rate, the rotor magnetic pole position is estimated to be 300 degrees, if it is the one from a negative value to a positive value of the U-phase current change rate, the rotor magnetic pole position is estimated to be 0 degrees, if it is the one from a positive value to a negative value of the W-phase current change rate, the rotor magnetic pole position is estimated to be 60 degrees, and if it is the one from a negative value to a positive value of the V-phase current change rate, the rotor magnetic pole position is estimated to be 120 degrees. On the other hand, if it is judged at step S4 that the calculated current change rate is not at the zero crossing point, the process returns to step S1.

As explained above, this embodiment is configured to detect the change rate of the phase current flowing through the synchronous motor M when the zero voltage vector is being generated, and estimate the rotor magnetic pole position on the basis of the detected current change rate. This estimation is based on the fact that each phase is in the short-circuited state, and accordingly the current flowing through the synchronous motor M is caused only by the induced voltage during the period in which the zero voltage vector is being generated. This embodiment does not require providing the idle period unlike the conventional 120-degree induced voltage method in which the rotor magnetic pole position is estimated on the basis of the zero crossing of the induced voltage in the 60-degree idle period. Accordingly, according to this embodiment, since it is possible to supply power to the synchronous motor by sinusoidal wave, the synchronous motor can be driven at high efficiency and low noise. In addition, this embodiment requires less computation load than the conventional extended induced voltage method in which the induced voltage is calculated theoretically in order to estimate the rotor magnetic pole position, and does not require any man-hour for adjusting estimated gains and device constants. Accordingly, according to this embodiment, control delay does not occur, because the induced voltage is not calculated theoretically, but directly detected.

Furthermore, since the rotor magnetic pole position is estimated by detecting the zero crossing of the current change rate, the rotor magnetic pole position can be estimated at 60-degree intervals without performing any computation.

It is preferable to set the period during which the zero voltage vector is being generate at a sufficiently large value to enable reliably detecting the change rate of the phase current flowing to the synchronous motor M at a timing outside a ringing time.

Alternatively, the zero vector may be generated at a specific timing in order to generate a diagnostic voltage to enable detecting the current change rate even when the modulation ratio is high to such an extent that the zero vector generating period is shorter than the ringing time.

It is preferable to perform position correction depending on the value and phase of the current flowing through the synchronous motor M, so that the rotor magnetic pole position can be further accurately estimated allowing for the effect of the coil reactance.

This embodiment may be modified to drive the synchronous motor M by two-phase modulation control in which only two of the three phases are subjected to switching control, in order to double the period in which the zero voltage vector V0 is being generated, to thereby expand the range of the modulation ratio within which the current change ratio can be detected.

It is a matter of course that various modifications can be made to the above described embodiment.

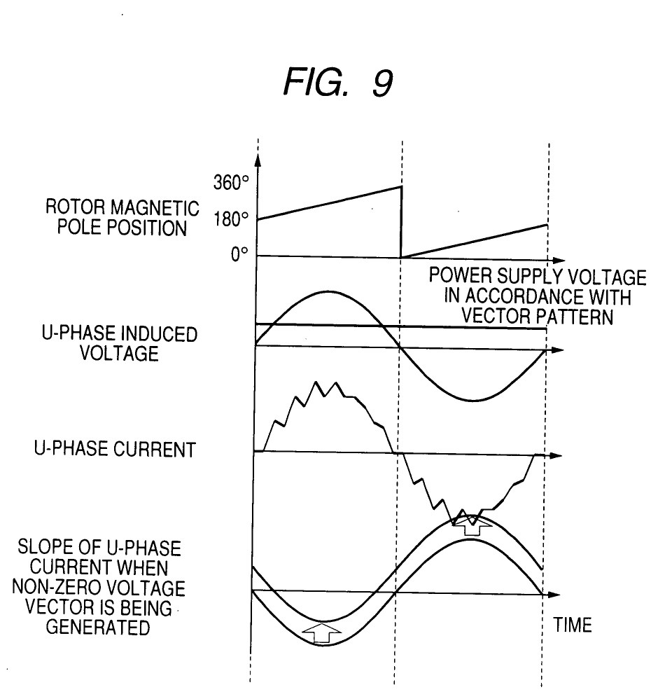

For example, although the rotor magnetic pole position is estimated on the basis of the current change rate when the zero voltage vector V0 or V7 is being generated, it may be detected on the basis of the current change rate when the non-zero voltage vector is being generated. In this case, the current change rate when the non-zero voltage vector is being generated at zero speed operation is stored in advance in the memory of the microcomputer 4 as a zero-speed current change rate, and a detected current change rate is subtracted by this zero-speed current change rate stored in the memory. And the rotor magnetic pole position is estimated on the basis of the result of this subtraction. FIG. 9 is a time diagram showing relationships among the rotor magnetic pole position, U-phase induced voltage, U-phase current, and U-phase current slope when the non-zero voltage vector is being generated. When the non-zero voltage vector is being generated, since the induced voltage and the power supply voltage in accordance with the vector pattern are applied to the motor, the current change rate cannot be detected on the basis of the induced voltage. However, during zero-speed operation, since the induced voltage is zero, the current change rate depends on only the power supply voltage in accordance with the vector pattern. Accordingly, by storing this current change rate at zero-speed operation in the memory, and performing subtraction of this stored current change rate from the current change rate detected not during the zero-speed operation, it becomes possible to detect the current change rate only due to the induced voltage.

This embodiment may be modified to estimate the rotational speed on the basis of the time intervals of the zero crossings of the current change rate, and to estimate the rotor magnetic pole position on the basis of the estimated speed. According to this modification, it becomes possible to estimate the rotor magnetic pole position also at timings other than the zero-crossing timings (white circle portions in FIG. 8).

This embodiment is configured to detect the phase currents on the basis of the voltage drops of the switching transistors of the three phase arms of the inverter circuit 2, however this embodiment may be modified to detect the phase current(s) on the basis of the voltage drop(s) of the switching transistor(s) of one or two of the three phase arms.

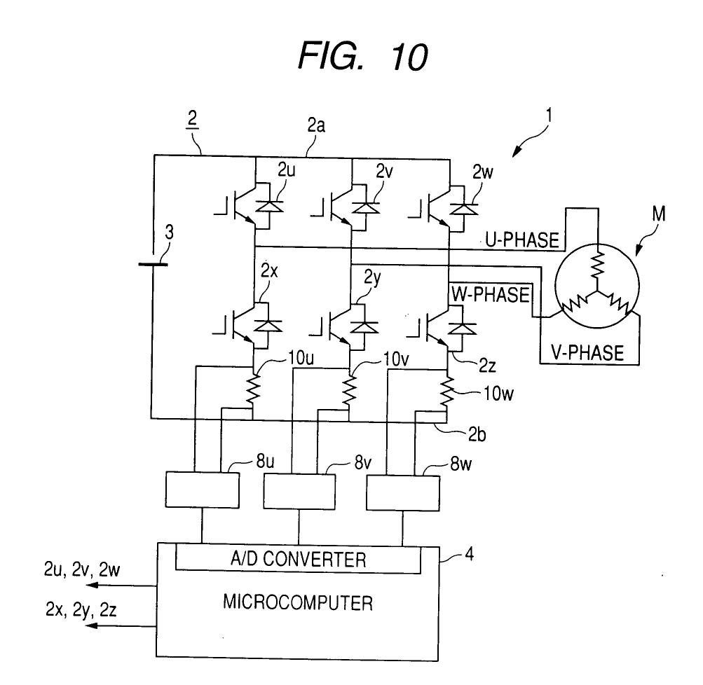

Although the phase current is detected on the basis of the voltage drops of the switching transistors of the three phase arms of the inverter circuit 2 in this embodiment, it may be detected on the basis of currents flowing through shunt resistors disposed above or below the phase arms. FIG. 10 is a variant of this embodiment configured to detect the phase currents on the basis of the voltage drops of shunt resistors 10u, 10v, 10w disposed below the phase arms.

This variant may be modified to detect the phase current(s) on the basis of the voltage drop(s) of one or two of the shunt resistors 10u, 10v, 10w.

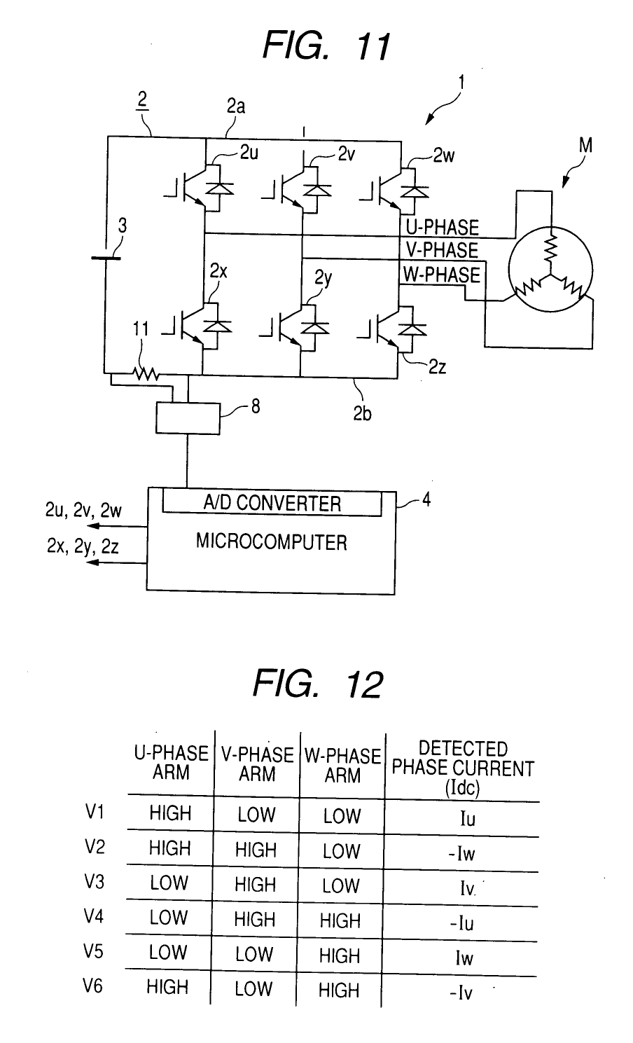

Also, the phase current may be detected on the basis of a current flowing through a single shunt resistor 11 provided in the DC bus 2b of the inverter circuit 2 as shown in FIG. 11. Next, explanation is given as to the relationships among the fundamental voltage vectors V1 to V6, switching patterns of the switching transistors of each phase corresponding to the fundamental voltage vectors V1 to V6, and the phase currents detected on the basis of the DC bus current with reference to Table of FIG. 12. The zero voltage vectors V0, V7 are excluded from the Table of FIG. 12, because the phase current detection is not performed during the period in which the zero voltage vector V0 or V7 is being generated, because a circulation mode occurs during this period. Each of the U-phase arm column, V-phase arm column, and W-phase arm column in the Table of FIG. 11 shows which of the switching transistor disposed above the phase arm and the switching transistor disposed below the phase arm should be turned at the time of generating the fundamental voltage vector shown at the leftmost side of the Table. In this Table, “High” shows that the switching transistor disposed above the phase arm should be turned on, and “Low” shows that the switching transistor disposed below the phase arm should be turned on. The column of detected phase current (idc) shows which phase current is equal to the DC bus current when the fundamental voltage vector shown at the leftmost side of the Table is being generated. In this Table, “Iu”, “Iv”, “Iw” respectively represent the phase currents flowing from the inverter 2 to the U-phase, V-phase, and W-phase, and “−Iu”, “−Iv”, “−Iw” respectively represent the phase currents flowing to the inverter 2 from the U-phase, V-phase, and W-phase. According to this variant, it becomes possible to perform the phase current detection by use of the single shunt resistor 11 provided in the DC bus. This enables to simplify the structure of the synchronous motor control apparatus and reduces the production cost thereof.

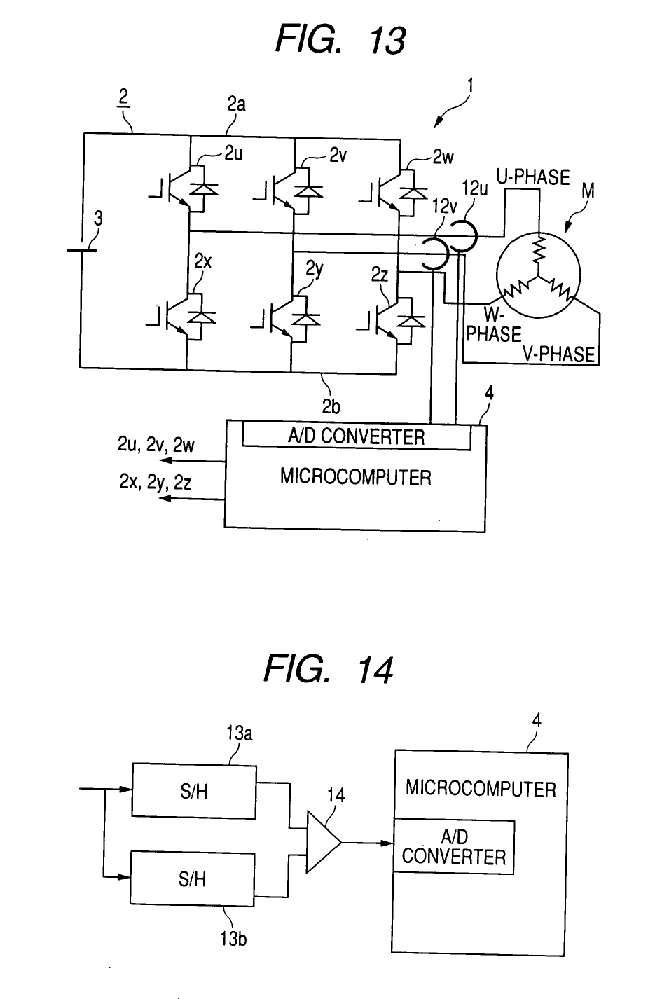

As shown in FIG. 13, two current transformers 12u, 12v may be respectively provided in two of the three phases (U-phase and V-phase in FIG. 13) to detect the phase currents. Alternatively, only one current transformer may be provided in only one of the three phases to detect the phase current.

The above described embodiment is configured to detect the current change rate by taking in the detected current values from the current detecting circuit 8 by causing the A/D converter to operate twice during the period in which the zero voltage vector is being generated. However, as shown in FIG. 14, this embodiment may be modified to include two sample-hold circuits 13a, 13b, and a difference calculating circuit 14 for calculating a difference between two detected current values that are respectively held in the two sample-hold circuits 13a, 13b at different timings during the period in which the zero voltage vector is being generated, so that the current change rate can be detected on the basis of the calculated difference.

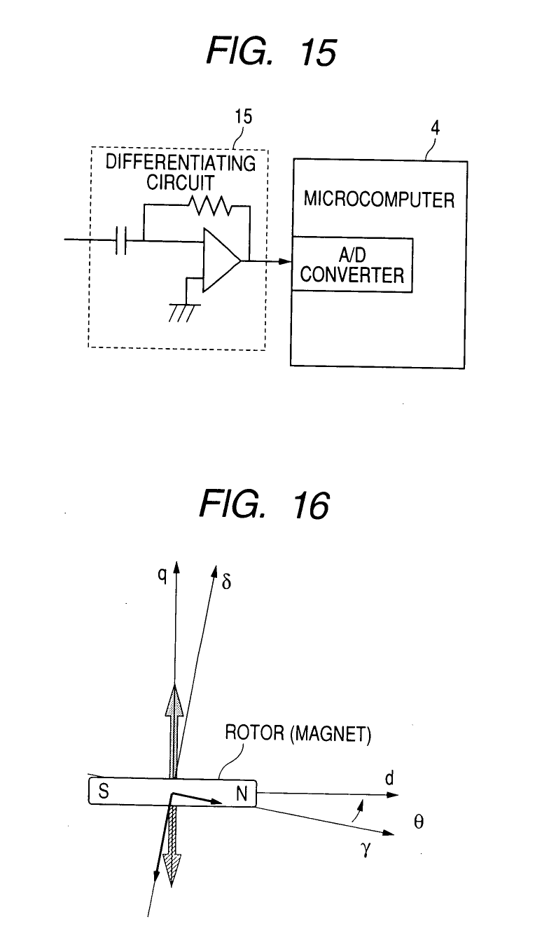

Alternatively, as shown in FIG. 15, this embodiment may be modified to include a differentiating circuit 15 for differentiating the current value detected by the current detecting circuit 8, so that the current change rate can be detected from the derivative of the detected current value outputted from the differentiating circuit 15.

This embodiment may be modified to estimate the rotor magnetic pole position (angle 0) from a ratio between a d-axis component and a q-axis component of a d-q converted version of the current change rate detected on the basis of the output of the current detecting circuit 8 in accordance with the following expression (1). FIG. 16 is a diagram showing the d-axis component and q-axis component of the detected current change rate. To be exact, in this figure, the current change rate is shown on an actually detactable γ δ axis.

$$θ = {tan}^{- 1} ( \frac{Δ {I}_{d}}{- Δ {I}_{q}} ) \qquad ( 1 )$$

According to this modification, the rotor magnetic pole position can be continuously estimated by a simple computation using an arctangent function. In addition this modification enables a high speed response, since it does not need filters.

This embodiment may be modified to dq-convert the current change rate detected on the basis of the output of the current detecting circuit 8, and estimate the rotor magnetic pole position to be a value at which the d-axis component of the dq-converted current change rate becomes substantially zero in accordance with the following expression (2).

$$θ = {K}_{p} Δ {I}_{d} + {K}_{i} \int Δ {I}_{d} d t \qquad ( 2 )$$

In the expression (2), Kₚ and Kᵢ are constants. According to this modification the rotor magnetic pole position can be continuously estimated by a computation simpler than an arctangent function.

This embodiment may be modified to dq-convert the current change rate detected on the basis of the output of the current detecting circuit 8, and estimate the rotor magnetic pole position to be a value at which the scalar product of a d-q component vector of the current change rate and an estimated position vector of the rotor becomes substantially zero in accordance with the following expression (3).

$$θ = {K}_{p} ( {θ}^{->} \cdot Δ {I}^{->} ) + {K}_{i} \int ( {θ}^{->} \cdot Δ {I}^{->} ) d t \qquad ( 3 )$$

According to this modification, the rotor magnetic pole position can be continuously estimated by a computation simpler than an arctangent function.

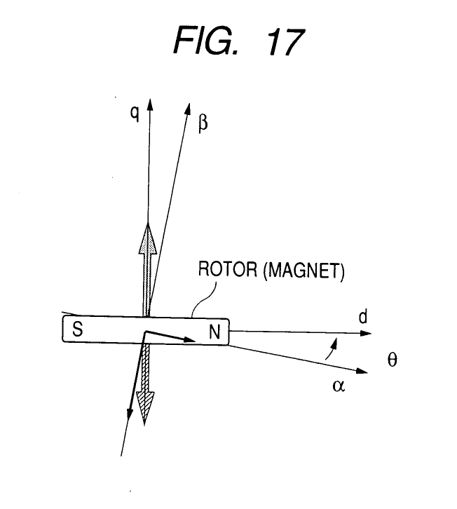

This embodiment may be modified to estimate the rotor magnetic pole position from a ratio between an β-axis component of an α-β converted version of the current change rate detected on the basis of the output of the current detecting circuit 8. FIG. 17 is a diagram showing the α-axis component and β-axis component of the detected current change rate.

$$θ = {tan}^{- 1} ( \frac{Δ {I}_{α}}{- Δ {I}_{β}} ) \qquad ( 4 )$$

According to this modification, the rotor magnetic pole position can be continuously estimated by a simple computation using an arctangent function. In addition this modification enables a high speed response, since it does not need filters.

This embodiment may be modified to α β-convert the current change rate detected on the basis of the output of the current detecting circuit 8, and estimate the rotor magnetic pole position to be a value at which the scalar product of an α-β component vector of the current change rate and an estimated position vector of the rotor becomes substantially zero.

$$θ = {K}_{p} ( {θ}^{->} \cdot Δ {I}^{->} ) + {K}_{i} \int ( {θ}^{->} \cdot Δ {I}^{->} ) d t \qquad ( 5 )$$

According to this modification, the rotor magnetic pole position can be always estimated by a computation simpler than an arctangent function.

Furthermore, this embodiment may be configured to estimate a rotational speed of the rotor on the basis of the estimated magnetic pole position, and integrating the estimated speed so that the rotor magnetic pole position can be estimated from the result of the integration when the generation period of the voltage vectors is smaller than a predetermined value. According to this configuration, the rotor magnetic pole position can be estimated in a case where it is not possible to estimate the rotor magnetic pole position on the basis of the current change rate.

The above explained preferred embodiments are exemplary of the invention of the present application which is described solely by the claims appended below. It should be understood that modifications of the preferred embodiments may be made as would occur to one of skill in the art.

What is claimed is:

1. A position sensorless control apparatus for controlling a synchronous motor having a permanent magnet rotor structure by generating fundamental voltage vectors used to designate on/off states of switching devices included in an inverter circuit thereof, said position sensorless control apparatus comprising:
a current change rate detecting section detecting, as a current change rate, a change rate of a phase current flowing through said synchronous motor when a predetermined one of said fundamental voltage vectors is being generated; and
a rotor magnetic pole position estimating section estimating, as a rotor magnetic pole position, a rotational position of a rotor of said synchronous motor on the basis of said current change rate detected by said current change rate detecting section.

2. The position sensorless control apparatus according to claim 1, wherein said current change rate detecting section detects said current change rate when a zero voltage vector is being generated so that said phase current is caused only by an induced voltage.

3. The position sensorless control apparatus according to claim 2, wherein a period of time during which said zero voltage vector is being generated is set longer than a predetermined value.

4. The position sensorless control apparatus according to claim 2, wherein said zero voltage vector is generated at a predetermined timing.

5. The position sensorless control apparatus according to claim 1, configured to perform two-phase modulation control.

6. The position sensorless control apparatus according to claim 1, wherein said current change rate detecting section detects said current change rate when a non-zero voltage vector is being generated so that said phase current is caused by an induced voltage and a power supply voltage of said synchronous motor.

7. The position sensorless control apparatus according to claim 6, further comprising a memory for storing, as a zero-speed current change rate, said current change rate detected by said current change rate detecting section when said non-zero voltage vector is being generated during a zero-speed operation of said synchronous motor, said rotor magnetic pole position estimating section being configured to subtract said zero-speed current change rate stored in said memory from said rotor magnetic pole position estimated by said current change rate detecting section not during said zero-speed operation.

8. The position sensorless control apparatus according to claim 1, wherein said rotor magnetic pole position estimating section estimates said rotor magnetic pole position by detecting a direction of zero crossing of said detected current change rate.

9. The position sensorless control apparatus according to claim 1, wherein said rotor magnetic pole position estimating section is configured to estimate a rotational speed of said rotor on the basis of intervals of zero crossings of said current change rate detected by said current change rate detecting section, and correct said rotor magnetic pole position estimated by said rotor magnetic pole position estimating section in accordance with said estimated rotational speed of said rotor.

10. The position sensorless control apparatus according to claim 1, further comprising a current detecting circuit detecting said phase current, said current change rate detecting section detecting said current change rate on the basis of said phase current detected by said current detecting circuit.

11. The position sensorless control apparatus according to claim 10, wherein said current detecting circuit detects said phase current on the basis of a voltage drop across at least one of said switching devices.

12. The position sensorless control apparatus according to claim 10, wherein said current detecting circuit detects said phase current on the basis of a current flowing through a shunt resistor provided in at least one of phase arms of said inverter circuit.

13. The position sensorless control apparatus according to claim 10, wherein said current detecting circuit detects said phase current on the basis of a current flowing through a shunt resistor provided in a DC current bus of said inverter circuit.

14. The position sensorless control apparatus according to claim 10, wherein said current detecting circuit detects said phase current on the basis of outputs of current sensors provided for each phase in said inverter circuit.

15. The position sensorless control apparatus according to claim 10, further comprising an A/D converter for A/D converting said phase current detected by said current detecting circuit, said current change rate detecting section being configured to cause said A/D converter to operate twice during a period in which said predetermined one of said fundamental voltage vectors is being generated in order to detect said current change rate on the basis of two values of said phase current taken in at different timings.

16. The position sensorless control apparatus according to claim 10, wherein said current change rate detecting section includes two sample-hold circuits for holding two values of said phase current detected at different timings by said current detecting circuit during a period in which said predetermined one of said fundamental voltage vectors is being generated, and a difference calculating circuit for calculating a difference between said two values of said phase current stored in said two sample-hold circuits, and is configured to detect said current change rate on the basis of said difference calculated by said difference calculating circuit.

17. The position sensorless control apparatus according to claim 10, wherein said current change rate detecting section includes a differentiating circuit for differentiating said phase current detected by said current detecting circuit, and is configured to detect said current change rate on the basis of a derivative of said phase current outputted from said differentiating circuit.

18. The position sensorless control apparatus according to claim 1, wherein said rotor magnetic pole position estimating section is configured to d-q convert said current change rate detected by said current change rate detecting section, and estimate said rotor magnetic pole position on the basis of a ratio between a d-axis component and a q-axis component of said d-q converted current change rate.

19. The position sensorless control apparatus according to claim 1, wherein said rotor magnetic pole position estimating section is configured to d-q convert said current change rate detected by said current change rate detecting section, and estimate said rotor magnetic pole position to be a value at which a d-axis component of said d-q converted current change rate becomes substantially zero.

20. The position sensorless control apparatus according to claim 1, wherein said rotor magnetic pole position estimating section is configured to d-q convert said current change rate detected by said current change rate detecting section, and estimate said rotor magnetic pole position to be a value at which a scalar product of a d-q component vector of said d-q converted current change rate and an estimated position vector of said rotor becomes substantially zero.

21. The position sensorless control apparatus according to claim 1, wherein said rotor magnetic pole position estimating section is configured to α-β convert said current change rate detected by said current change rate detecting section, and estimate said rotor magnetic pole position on the basis of a ratio between an α-axis component and β-axis component of said α-β converted current change rate.

22. The position sensorless control apparatus according to claim 1, wherein said rotor magnetic pole position estimating section is configured to α-β convert said current change rate detected by said current change rate detecting section, and estimate said rotor magnetic pole position to be a value at which a scalar product of an α-β component vector of said α-β converted current change rate and an estimated position vector of said rotor becomes substantially zero.

23. The position sensorless control apparatus according to claim 1, wherein said rotor magnetic pole position estimating section is configured to correct said estimated rotor magnetic pole position in accordance with said phase current flowing to said synchronous motor.

24. The position sensorless control apparatus according to claim 1, wherein said rotor magnetic pole position estimating section is configured to estimate a rotational speed of said rotor on the basis of said estimated rotor magnetic pole position, integrate said estimated rotational speed when a period during which said predetermined one of said fundamental voltage vectors is being generated is shorter than a predetermined value, and estimate said rotor magnetic pole position on the basis of integration result of said estimated speed.
